(19) United States
(12) Patent Application Publication
(10) Pub. No.: US 2023/0186125 A1
(43) Pub. Date: Jun. 15, 2023

(54) HUMAN DATA DRIVEN EXPLAINABLE ARTIFICIAL INTELLIGENCE SYSTEM AND METHODS

(71) Applicant: GM Global Technology Operations LLC, Detroit, MI (US)

(72) Inventors: Claudia Goldman-Shenhar, Mevasseret Zion (IL); Ronit Bustin, Kfar Saba (IL)

(21) Appl. No.: 17/551,735

(22) Filed: Dec. 15, 2021

(51) Int. Cl. G06N 5/04

(52) U.S. Cl. CPC G06N 5/045

(57) ABSTRACT

An autonomous vehicle and a system a method of operating a machine. The system includes a processor. A set of explanations related to a machine behavior of the machine is generated. The processor generates a model that relates an explanation for the behavior taken in response to a scenario to a trust level that a human has in the behavior when the explanation is presented to the human, the explanation being selected from the set of explanations. The processor performs the behavior of the system of vehicle in response to the scenario, uses the model to select the explanation when the behavior is taken, and presents the explanation to the human.

### INTRODUCTION

The subject disclosure relates to artificial intelligence systems that interact with humans and, in particular, to a system and method for presenting an explanation of an action taken by the artificial intelligence system to a human end user of the artificial intelligence system to increase a level of trust the human end user has in the action.

An automated machine can use artificial intelligence when interacting with a human being. The human can observe an action taken or machine behavior by the automated machine and, as a result, develop a trust or distrust in the action taken or machine behavior. In an embodiment, the automated machine includes a semi-autonomous or fully autonomous vehicle that includes a system for navigating through a traffic scenario by selecting and performing a maneuver suited to the traffic scenario. The human being can be a driver or passenger in the vehicle that is observant of the maneuver. When the maneuver is an unexpected one from the point of view of the passenger, the passenger can develop a level of anxiety or discomfort. If this anxiety is not addressed or mitigated, the driver may decide to take over control of the autonomous vehicle for the remainder of a trip, not to continue to ride, or even to avoid using the autonomous vehicle on future trips. Accordingly, it is desirable to be able to communicate with the passenger in order to reduce discomfort levels and to increase a level trust that the passenger has in the vehicle’s maneuvers.

### SUMMARY

In one exemplary embodiment, a method of operating a machine is disclosed. A set of explanations related to a machine behavior of the machine is generated. A model is generated that relates an explanation for the machine behavior taken by the machine in response to a scenario to a trust level that a human has in the machine behavior when the explanation is presented to the human, the explanation being selected from the set of explanations. The machine behavior is performed in response to the scenario. The explanation is selected, using the model, when the machine behavior is taken by the machine. The explanation is presented to the human.

In addition to one or more of the features described herein, generating the model further includes showing the scenario, the machine behavior and the explanation to a test subject and recording the trust level registered by the test subject for the machine behavior based on the explanation. The model is at least one of tailored to a demographic of the human and tailored to the scenario. In an embodiment, the machine is a vehicle, the scenario is a traffic scenario and the machine behavior action is a maneuver of the vehicle for the traffic scenario. In an embodiment, the model includes the trust level of the test subjects and the explanation is selected that generates a maximum response from the test subjects for the trust level. In an embodiment, the model includes an effectiveness of the explanation in increasing the trust level that occurs between a first showing of the machine behavior to the test subject without the explanation and a second showing of the machine behavior to the test subject with the explanation. In an embodiment, the method includes selecting a subset of explanations to present to the human, wherein subset is selected using at least one of optimizing a mutual information measure with respect to a constraint on a cardinality of the subset and optimizing the mutual information measure that balances a trade-off between the cardinality and information.

In another exemplary embodiment, a system is disclosed. The system includes a processor. The processor is configured to generate a set of explanations related to a behavior of the system, generate a model that relates an explanation for the behavior taken in response to a scenario to a trust level that a human has in the behavior when the explanation is presented to the human, the explanation being selected from the set of explanations, perform the behavior in response to the scenario, select, using the model, the explanation when the behavior is taken, and present the explanation to the human.

In addition to one or more of the features described herein, the processor is further configured to generate the model by showing the scenario, the behavior and the explanation to a test subject and recording the trust level registered by the test subject for the behavior based on the explanation. The processor is further configured to perform at least one of tailoring the model to a demographic of the human and tailoring the model to the scenario. In an embodiment, the model includes a record of the trust level of test subjects and the explanation is selected that generates a maximum response from the test subjects for the trust level. In an embodiment, the model includes a record of an effectiveness of the explanation in increasing the trust level that occurs between a first showing of the behavior to the test subject without the explanation and a second showing of the behavior to the test subject with the explanation. In an embodiment, the processor is further configured to select a subset of explanations to present to the human by performing at least one of optimizing a mutual information measure with respect to a constraint on a cardinality of the subset and optimizing the mutual information measure that balances a trade-off between the cardinality and information.

In yet another exemplary embodiment, an autonomous vehicle is disclosed. The autonomous vehicle includes a processor. The processor is configured to generate a set of explanations related to a behavior of the autonomous vehicle, generate a model that relates an explanation for a maneuver taken by the autonomous vehicle in response to a traffic scenario to a trust level that a human has in the autonomous vehicle when the explanation is presented to the human, the explanation being selected from the set of explanations, perform the maneuver at the autonomous vehicle in response to the traffic scenario, select, using the model, the explanation for the maneuver when the autonomous vehicle performs the maneuver, and present the explanation to the human.

In addition to one or more of the features described herein, the processor is further configured to generate the model by showing the traffic scenario, the maneuver and the explanation to a test subject and recording the trust level registered by the test subject for the maneuver based on the explanation. The processor is further configured to perform at least one of tailoring the model to a demographic of the human and tailoring the model to the scenario. In an embodiment, the model includes a record of the trust level of test subjects and the explanation is selected that generates a maximum response from the test subjects for the trust level. In an embodiment, the model includes a record of an effectiveness of the explanation in increasing the trust level that occurs between a first showing of the maneuver to the test subject without the explanation and a second showing of the maneuver to the test subject with the explanation. In an embodiment, the processor is further configured to select a subset of explanations to present to the human by performing at least one of: (i) optimizing a mutual information measure with respect to a constraint on a cardinality of the subset; and (ii) optimizing the mutual information measure that balances a trade-off between the cardinality and information. In an embodiment, the processor is configured to generate the model using a simulation of the traffic scenario in an offline mode and select the favored explanation in response to a real-time occurrence of the traffic scenario in an online mode.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram representing operation of an autonomous machine to perform an action that is entrusted by a human;

FIG. 2 shows an autonomous vehicle;

FIG. 3 is a schematic diagram of a method for operating the autonomous machine to generate an explanation for a machine action taken by the machine in response to a scenario in order to increase a trust of a human in the proposed action;

FIG. 4 shows a flowchart of a method for providing an optimal or favored explanation for a machine action to a user;

FIG. 5 shows a snapshot of a movie created for a selected traffic scenario; and

FIG. 6 shows a graph illustrating the effects of presenting various explanations for the second implementation.

### DETAILED DESCRIPTION

The following description is merely exemplary in nature and is not intended to limit the present disclosure, its application or uses. It should be understood that throughout the drawings, corresponding reference numerals indicate like or corresponding parts and features.

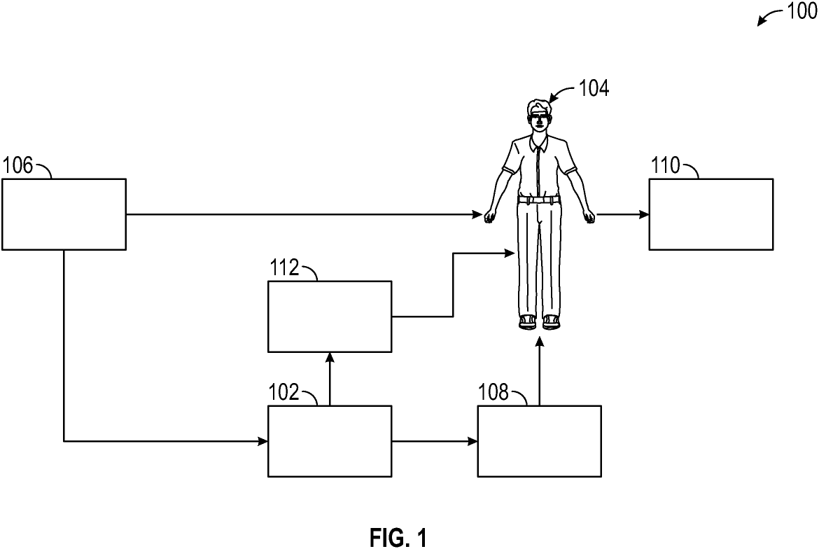

In accordance with an exemplary embodiment, FIG. 1 is a schematic diagram 100 representing operation of an autonomous machine 102 (or autonomous system) to perform an action that is entrusted by a human 104. The autonomous machine 102 observes a scenario 106 and performs a machine action 108 in response to the scenario. A machine action 108 is also referred to herein as a machine behavior. The machine uses artificial intelligence (AI), machine language programming, neural networks, or other methods for determining a machine action in response to a scenario. The machine action 108 can aid an action by the human 104 or can be used in place of an action by the human. The human 104 generally also observes the scenario 106 and reaches a conclusion about an expected action to be taken in response to the scenario. When the human 104 observes both the scenario 106 and the machine action 108, the degree to which the machine action matches the expected action leads to a level of trust 110 that the human 104 has with respect to the operation of the autonomous machine 102. Inversely, the degree to which the machine action 108 does not match the expected action leads to a level of mistrust that the human 104 has in the operation of the autonomous machine 102.

In an embodiment, the autonomous machine 102 provides an explanation 112 of its machine action 108 to the human 104 in order to increase a level of trust that the human has in the operation of the machine and to mitigate a misunderstanding or level of discomfort due to a difference between the machine action and an action expected by the human. The explanation 112 can be presented to the human 104 simultaneously or near-simultaneously with the machine action 108 so that the human can refer to the explanation when a level of mistrust or discomfort occurs.

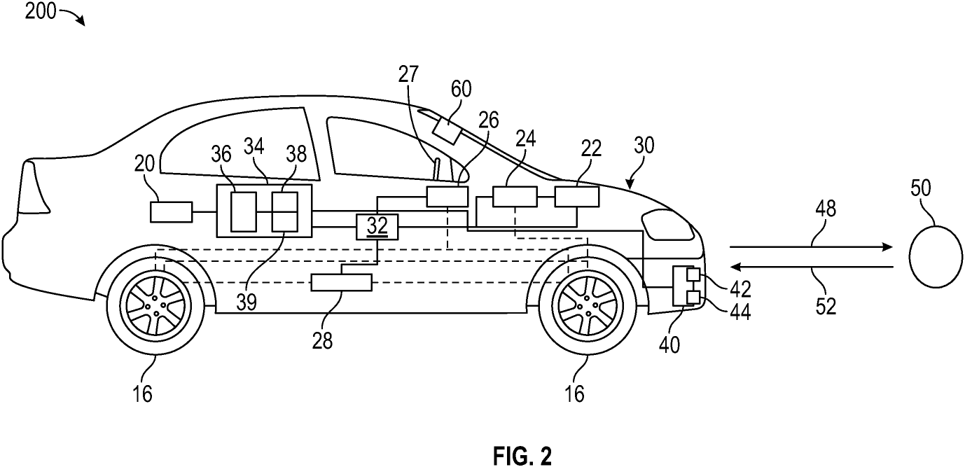

FIG. 2 shows an autonomous vehicle 200. In various embodiments, the autonomous machine 102 of FIG. 1 can be an autonomous vehicle 200. For an autonomous vehicle 200, the scenario 106 is a traffic scenario. The machine action 108 can be a maneuver that the autonomous vehicle takes in response to the traffic scenario. The human 104 can be a passenger, driver, or other user of the autonomous vehicle 200. The autonomous vehicle 200 can provide an explanation to the human 104 in order to increase or maximize the amount of trust of the human 104 has in the maneuver taken by the vehicle.

The autonomous vehicle 200 can offer any of autonomous levels from Levels One through Level Five. In various embodiments, the vehicle can be a semi-autonomous vehicle or a fully autonomous vehicle. In an exemplary embodiment, the autonomous vehicle 200 is a so-called Level Four or Level Five automation system. A Level Four system indicates “high automation,” referring to the driving mode-specific performance by an automated driving system of all aspects of the dynamic driving task, even if a human driver does not respond appropriately to a request to intervene. A Level Five system indicates “full automation,” referring to the full-time performance by an automated driving system of all aspects of the dynamic driving task under all roadway and environmental conditions that can be managed by a human driver.

The autonomous vehicle 200 generally includes at least a navigation system 20, a propulsion system 22, a transmission system 24, a steering system 26, a brake system 28, a sensor system 30, an actuator system 32, and a controller 34. The navigation system 20 determines a road-level route plan for automated driving of the autonomous vehicle 200. The propulsion system 22 provides power for creating a motive force for the autonomous vehicle 200 and can, in various embodiments, include an internal combustion engine, an electric machine such as a traction motor, and/or a fuel cell propulsion system. The transmission system 24 is configured to transmit power from the propulsion system 22 to two or more wheels 16 of the autonomous vehicle 200 according to selectable speed ratios. The steering system 26 influences a position of the two or more wheels 16. While depicted as including a steering wheel 27 for illustrative purposes, in some embodiments contemplated within the scope of the present disclosure, the steering system 26 may not include a steering wheel 27. The brake system 28 is configured to provide braking torque to the two or more wheels 16. In an embodiment, the autonomous vehicle 200 can be an electrical vehicle in various embodiments. In other embodiments, the autonomous vehicle 200 can include an autonomous vessel, a plane, or a machine used for agricultural purposes.

The sensor system 30 includes a radar system 40 that senses objects in an exterior environment of the autonomous vehicle 200 and determines various parameters of the objects useful in locating the position and relative velocities of various remote vehicles in the environment of the autonomous vehicle. Such parameters can be provided to the controller 34. In operation, the transmitter 42 of the radar system 40 sends out a radio frequency (RF) reference signal 48 that is reflected back at the autonomous vehicle 200 by one or more objects 50 in the field of view of the radar system 40 as one or more echo signals 52, which are reflected signals received at receiver 44. The one or more echo signals 52 can be used to determine various parameters of the one or more objects 50, such as a range of the object, Doppler frequency or relative radial velocity of the object, and azimuth, etc. The sensor system 30 includes additional sensors, such as digital cameras, for identifying road features, Lidar, etc.

The controller 34 builds a trajectory for the autonomous vehicle 200 based on the output of sensor system 30. The controller 34 can provide the trajectory to the actuator system 32 to control the propulsion system 22, transmission system 24, steering system 26, and/or brake system 28 in order to navigate the autonomous vehicle 200 with respect to the object 50.

The controller 34 includes a processor 36 and a computer readable storage device or computer readable storage medium 38. The storage medium includes programs or instructions 39 that, when executed by the processor 36, perform the methods disclosed herein for operating the autonomous vehicle 200 based on sensor system outputs. The computer readable storage medium 38 may further include programs or instructions 39 that when executed by the processor 36, provides an explanation to the passenger regarding a vehicle maneuver in order to increase trust or reduce a level of uncertainty, surprise, or anxiety in the passenger. The computer readable storage medium 38 can be a remote medium such as a cloud server accessible from a mobile device or mobile application, in various embodiments.

A human-machine interface (HMI 60) can be used to present an explanation to the driver when the autonomous vehicle 200 makes a maneuver autonomously. The HMI 60 can also show a visual or audible representation of the maneuver as the autonomous vehicle 200 is making the maneuver or before the autonomous vehicle 200 makes the maneuver. The explanation provided at the HMI 60 can be, for example, a visual presentation, a speech application, a haptic interface, a lighting, a scent, or any combination thereof.

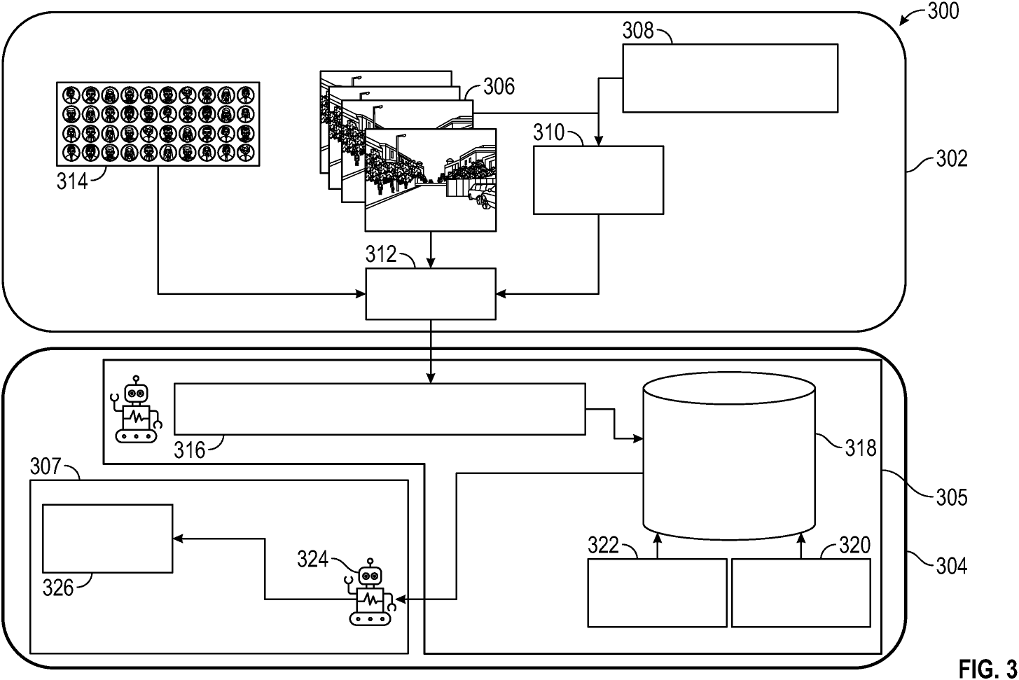

FIG. 3 is a schematic diagram 300 of a method for operating the autonomous machine 102 to generate an explanation for a machine action taken by the machine in response to a scenario in order to increase a trust of a human in the proposed action.

The method includes a first stage and a second stage. In the first stage 302, a user study is designed and executed to obtain a probabilistic model. The first stage 302 is performed offline relative to the driving time (i.e., the time when a particular ride is actually taken). The second stage 304 includes an offline portion 305 and an online portion 307. In the offline portion 305, the data collected in the first stage 302 from the user study is analyzed to determine a “best” explanation or favored explanation for a given scenario and human user. In the online portion 307, the machine, acting in response to a real-time scenario, outputs a favored explanation for a machine action generated for the real-time scenario. In the first stage 302, the autonomous machine 102 proposes a machine action in response to a scenario. An experimenter designs a set of explanations for the machine action to present to the human when the machine action is performed in response to the scenario. A plurality of scenarios 306 are provided. The plurality of scenarios 306 can be traffic simulations or previously recorded traffic conditions. An Artificial Intelligence (AI) decision-making framework or AI machine 308 receives the plurality of scenarios 306 and proposes a machine action for each of the plurality of scenarios. A set of explanations 310 is constructed by an experimenter or designer. The choice of which explanations are to be provided from the set of explanations by the vehicle to the passenger is based on an analysis of input from human test subjects in an experiment that uses the set of explanations. The machine action and set of explanations 310 are used in a user study 312 to determine a human understanding of a machine action or behavior and to determine an impact of the explanation on the human’s understanding and trust.

A group of test subjects 314 take part in the user study 312 to determine the effectiveness of the explanations 310 in building a trust of a human in a machine action. The user study 312 includes presenting the scenarios 306, proposed actions and explanations 310 to the test subjects 314. The test subjects 314 provide data, input, reactions, or responses to indicate the level of comfort or discomfort, trust, or distrust, etc., in the proposed action once they are presented the explanation.

In the offline portion 305 of the second stage 304, a data analysis 316 is applied to the input (from the test subjects) to generate a model 318. The model 318 is a probabilistic model that relates an explanation presented to the test subjects to an effectiveness of the explanation in increasing a level of trust of the test subjects 314 in a machine action. In various embodiments, the model 318 can be tailored to a selected demographic of the population of the test subjects, such as by gender, age, etc. For example, a first explanation for a maneuver may be more effective in increasing a trust in the maneuver for a young driver while a second explanation may be more effective for an older driver.

In the online portion 307 of the second stage 304, the model 318 is accessed to present an explanation for an action taken in a real-time scenario. The machine action 320 (e.g., the vehicle maneuver) selected by the vehicle is monitored and once the machine action is recognized, the model 318 extracts a favored explanation 324 for the machine action to present to the user. The demographic 322 of the passenger can also be input to the model 318 so that the model 318 extracts a favored explanation 324 for the machine action 320 that is compatible with the demographic 322 of the passenger, based on the results of the user study. The favored explanation can be selected using a maximal value or optimal value, in various embodiments. The favored explanation can be a single explanation or a set of explanations. The favored explanation 324 is presented to the human through a human-machine interface (HMI) 326. The HMI 326 can be a visual display, an audio device, or other suitable interface, or a combination thereof.

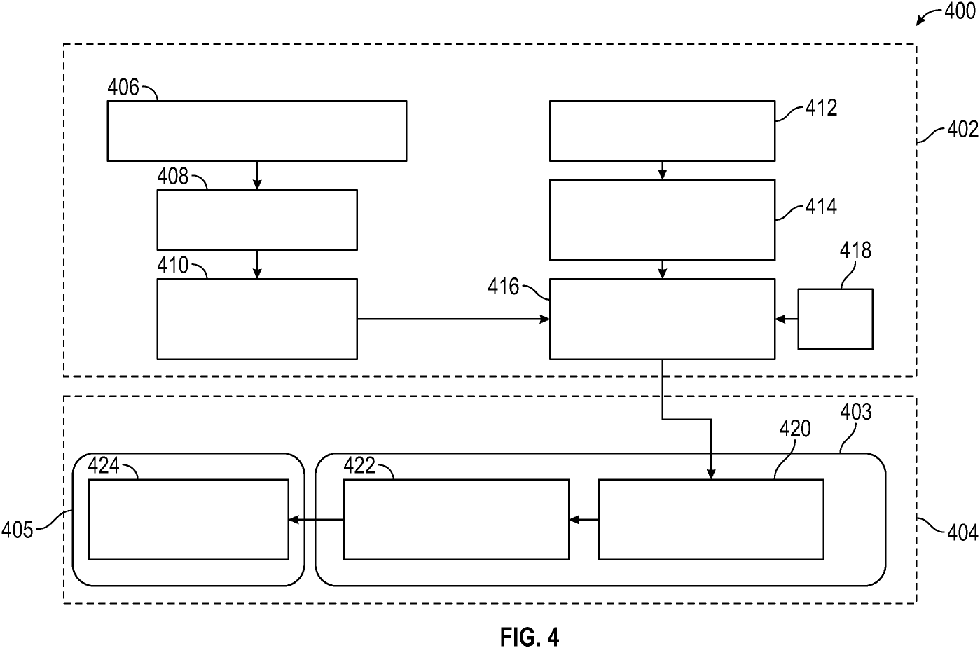

FIG. 4 shows a flowchart 400 of a method for providing an optimal or favored explanation for a machine action to a user. The method includes a first stage 402 and a second stage 404. In the first stage 402 (which is performed entirely offline), the autonomous machine 102 generates the model 318. In the second stage 404 (which is performed partially offline 403 and partially online 405), the autonomous machine 102 computes the “best” explanation (or favored explanation) from the set of explanations 310, receives data about a real-time scenario and outputs an explanation for the machine action to the user.

Referring to the first stage 402, in box 406, a plurality of scenarios are compiled or collected. In box 408, a movie is created for each of the plurality of contexts, which cause a need for an interaction between the machine and its end user (e.g., vehicle and passenger). In box 410, each movie is augmented with an HMI 60. The augmented movie shows a scenario and an action taken by a machine in response to the scenario. In box 412, a list of explanations reflecting (or matching) the AI framework is constructed, which are shown in box 414. In box 416, the augmented movies and the list of explanations are used in a user study. A trust criterion 418 or trust measure is provided to the user study to allow the test subjects to register their level of trust in the action based on an explanation.

In the user study, test subjects view the augmented movie and register their level of trust in the machine action using the trust criteria. The ability of the explanation to increase (or decrease) the level of trust for the machine’s actions can be recorded and used to create the probabilistic model.

Referring to the second stage 404, in box 420, the probabilistic model is constructed from the collected data. In box 422, the machine action or maneuver is used (offline) to select a “best” or favored explanation using the model, for each scenario and based on demographics of the user or driver. In box 424, the favored explanation is presented to the user or driver. The type of explanation is chosen for a certain context (driving scenario) offline. In real time, some particular parts of the explanation is set based on an actual driving scenario. For example, if during the offline mode, the machine learns to associate an explanation to a selected merge maneuver, the during the ride in real time, a specific element of the selected merge maneuver can be provided to the driver in the explanation.

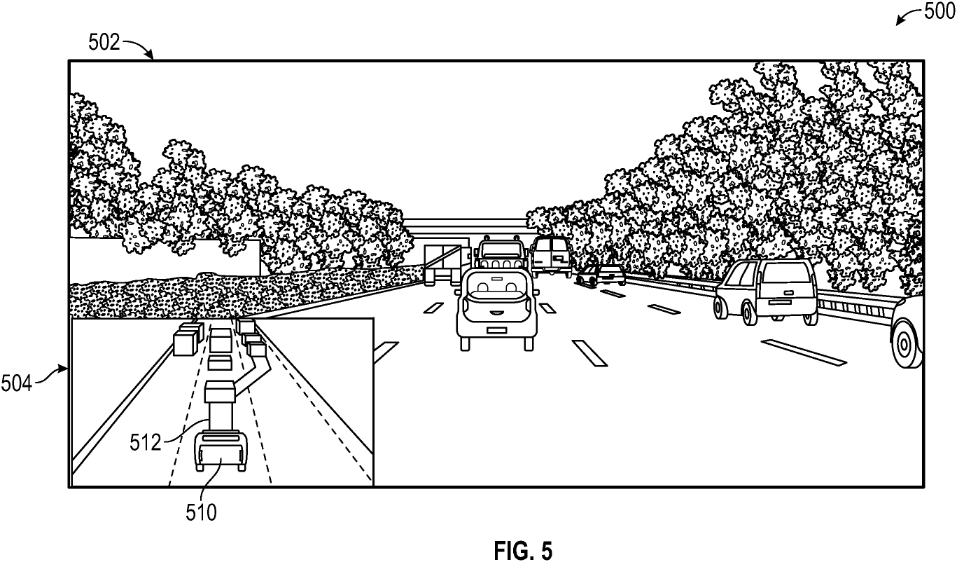

FIG. 5 shows a snapshot of a movie 500 created for a selected traffic scenario. The movie 500 can be a simulation of a traffic scenario in various embodiments. Alternatively, the movie 500 can be a recording of a previously encountered traffic scenario. The movie 500 includes a display area 502 in which the traffic scenario is displayed. An HMI display 504 in the lower left-hand corner of the display area 502 augments the movie 500. The HMI display 504 shows a simulation of the traffic scenario. A representation of the host vehicle 510 (i.e., the autonomous vehicle 200) is shown in the HMI display 504 as well as a proposed action 512 for the host vehicle.

Table 1 shows a listing of explanation categories that can be accessed to provide an explanation to the driver or passenger. The first column of Table 1 includes the broad category of explanations and the second column of Table 1 shows an illustrative explanation within the category that may be presented to a user for a particular maneuver. The category of explanations

TABLE 1

| | |
|---|---|
| Explanation Category | Explanation for lane change |
| Current State | “I am changing lanes because the speed of the incoming car allows us to overtake the parked van.” |
| Risk/uncertainty | “I am changing lanes because the situation is risky, but I am confident I can make a successful maneuver.” |
| Plan - next | “I am changing lanes because I plan to overtake the blacking vehicle and then return to the right lane.” |
| Counterfactual (action) | “I am changing lanes because otherwise, we would have waited behind the van for a long time.” |
| Counterfactual (state) | “I am changing lanes because the speed of the incoming car allows us to overtake the parked van” |

An explanation within a “Current State” category is an explanation based on the current state of the host vehicle. An explanation within a “Risk/Uncertainty” category explains how the maneuver reduces a risk to the vehicle for the scenario. An explanation within a “Plan-Next” category explains the maneuver with respect to a future maneuver intended by the vehicle. An explanation within a “Counterfactual (action)” category explains the action by stating what is likely to happen if a different action is performed. An explanation with a “Counterfactual (state)” category explains the outcome state with respect to the expected state that would have occurred had a different action been taken. A “Positive” category (not listed) indicated a positive outcome that results when the action is taken (e.g., “The car succeeded to merge to the target lane despite the traffic on that lane”).

The “best” explanation or favored explanation can be selected based on a probabilistic model built from test subject data. Selecting a favored explanation can be performed using one of at least three implementations. In a first implementation, the favored explanation is selected that generates the highest level of trust for a passenger. The trust level can be measured as a level of comfort reported by the user, by the level of understanding the user has for the maneuver, or by whether the user would or would not consider taking manual control of the machine. In a second implementation, the favored explanation is selected that generates the greatest increase in trust for the passenger between a first trust level that occurs when a first explanation is presented to the passenger and a second trust level that occurs when a second explanation is subsequently presented to the passenger after the first explanation (after the first trust level has been reached). In the third implementation, a group of explanations can be selected for presentation to the passenger as a composite explanation. The group is selected to balance a trade-off between complexity of explanation and an impact of the group on the trust level.

Referring first to the first implementation, an explanation is selected that optimizes or maximizes a level of trust in the action, according to a selected criterion. The selection process can be performed as shown in Eq. (1):

$${e}_{o p t} = {arg max}_{{e}_{i}} P r \left(T r u s t \vert {e}_{i} , M\right)$$

where M is a set of maneuvers of the vehicle (or a set of behaviors of some machine that using AI algorithms to control its behavior), eᵢ is the i^{th} explanation from a list of explanations and Trust is a quantity that is determined from the user study. Probability distribution Pr provides a probability of producing a trust value in a human end user (e.g., a passenger) when an explanation for a maneuver or action is presented to the human end user. The optimal explanation eₒₚₜ is determined by applying the argmax function to the probability distribution Pr to select the explanation that generates a highest trust level for a given maneuver M or action. The set of maneuvers M can also be can also be designed for a demographic category (i.e., gender, age of the driver, etc.). The maximization is over all possible explanations eᵢ that were presented to the test subjects for the maneuver.

The explanations eᵢ are explanations from at least the following categories or combination of categories {Risk, Plan-Next, Risk and Plan-Next, first counterfactual, second counterfactual, first positive, second positive, current state} which can be found in Table 1. The categories are exemplary categories that are applicable with respect to the autonomous vehicle. However, these categories can also be applicable to other autonomous machines such as autonomous machines that are controlled by an AI algorithm such as by using a Markov Decision Process decision-making framework.

Table 2 is a trust table showing probabilistic distributions of trust that occurs when various explanations are presented. The first column has a list of a trust measures that are used by test subjects to indicate their level of trust. The Columns 2-5 show test results for various explanation methods. The second column (case study A) shows results when only the HMI interface is used to provide the explanation. The third column (case study B) shows results when the HMI interface and a risk explanation is provided. The fourth column (case study C) shows results when the HMI interface and a “Plan-Next” explanation is provided. The fifth column (case study D) shows results when the HMI interface, “Risk” explanation and a “Plan-Next” explanation are provided. For each case study, poll results and percentages are presented.

TABLE 2

| Trust Measure | A | B | C | D |
|---|---|---|---|---|
| I do not at all understand the maneuver or why the vehicle made it | 10% | 10% | 9% | 10% |
| I do not understand why the vehicle made the maneuver | 15% | 12% | 12% | 13% |
| I somewhat understand why the vehicle made this maneuver | 24% | 25% | 23% | 25% |
| I understand why the vehicle made this maneuver | 29% | 31% | 30% | 28% |
| I completely understand why the vehicle made this maneuver | 22% | 22% | 25% | 24% |
| Understand/completely understand (top two boxes) | 50% | 53% | 55% | 52% |
| Do not at all/Do not understand (bottom two boxes) | 25% | 22% | 22% | 23% |

The sixth row of Table 2 is the summation of the fourth and fifth rows (“I understand why the vehicle made this maneuver” and “I completely understand why the vehicle made this maneuver”). The seventh (last) row is the summation of the first and second rows (“I do not at all understand the maneuver or why the vehicle made it” and “I do not understand why the vehicle made the maneuver”).

For illustrative purposes, the trust measure “I completely understand the maneuver and why the vehicle made it” is discussed. For case study A (HMI only), a 22% agreement with the trust measure is reached. For case study B (HMI + Risk), a 22% agreement is reached. For case study C (HMI + “Plan-Next”), a 25% agreement is reached. For case study D (HMI + Risk + Plan-Next), a 24% agreement is reached.

In one embodiment, in order to achieve an optimal agreement with this trust measure, the vehicle can decide to always select the explanation method of case study C. If the trust measure for one explanation is not significantly larger than for the other explanations, the system can decide to select a simplest explanation method (i.e., case study A). However, since the trust measure for the explanation of case study C is significantly greater than the trust measure for the explanations of case studies A, B and D (for “I completely understand the maneuver and why the vehicle made it”), the explanation for case study C is chosen.

In a second example of the first implementation, a different set of trust measures is shown. Table 3 is a trust table showing optimal explanation methods for difference scenarios and trust measures. Table 3 considers six different maneuvers M (e.g., LCOD (lane change on demand), urban LC (lane change in an urban area), early merge, late merge, early exit, late exit) separately and indicates which explanation(s) should be given for each maneuver to obtain each of three trust measures.

TABLE 3

| | | | | | | |
|---|---|---|---|---|---|---|
| Trust Measure | LCOD | Urban Lane Change | Early Merge | Late Merge | Early Exit | Late Exit |
| Comfort | Plan-Next + HMI | HMI only or Plan-Next + HMI | HMI only | Plan-Next + Risk + HI | Risk + HMI | Plan-Next + Risk + HMI |
| Understanding | Plan-Next + HMI | Plan-Next + HMI | Plan-Next + HMI | Risk + HMI | Plan-Next + HMI | Plan-Next + Risk + HMI |
| Avoid Taking Over | Risk + HMI/Risk+Plan-Next+HMI | HMI only | HMI only | Plan-Next +Risk + HMI | Risk + HMI | Risk + HMI |

The first column has a list of a trust measures that are used by test subjects to indicate their level of trust. The trust measures include the following: {Comfort, Understanding, Avoid Take Over} The “Comfort” trust measures indicates that the test subject is comfortable with the maneuver, machine action or machine behavior. The “Understand” trust measured indicates that the test subject is at least able to understand why the machine behaves as it does for a given scenario. The “Avoid Take Over” trust measure indicates that the test subject at least does not take over control of the vehicle and is the lowest level of trust for the driver.

Columns 2-7 of Table 3 show optimal explanation methods for the different traffic scenarios. When a selected maneuver is performed, Table 3 can be used to produce an explanatory method that achieves a desired level of trust.

In a third example of the first implementation, an explanation is selected to provide explanations selected from a large set of explanations. Table 4 is a trust table for this third example.

TABLE 4

| | | | | | | |
|---|---|---|---|---|---|---|
| Trust Measure | LCOD | Urban Lane Change | Early Merge | Late Merge | Early Exit | Late Exit |
| Avoid Taking Over | Risk/ Risk+Plan- | Positive 1 | Plan Next/ | Current State | Positive 1 | Positive 2 |
| | Next/ Current State | | Positive 2 | | | |

Six maneuvers are shown and the favored explanatory methods for the trust measure “Avoid Taking Over” are shown for each maneuver.

Referring now to the second implementation, the favored explanation is the explanation that increases a level of trust by a greatest amount. In a first part of the user study, the test subject is first shown a proposed maneuver for a scenario. The test subject is then polled to determine a trust level for the proposed maneuver. In a second part, the test subject is then presented with additional explanations for the maneuver. The test subject is polled a second time to determine the subject’s new level of trust upon being presented with each additional explanation. The additional explanations are presented independently. The difference between the first trust level and the second trust level indicates the effectiveness of the second explanation in changing the test subject’s trust level. A favored explanation can be selected using the selection process shown in Eq. (2):

$${e}_{o p t} = {arg max}_{{e}_{i}} P r \left(Δ T r u s t \vert {e}_{i} , M\right)$$

where ΔTrust is the change in trust produced by the explanation. The maximization is over all possible explanations eᵢ that were presented to the test subjects for the maneuver.

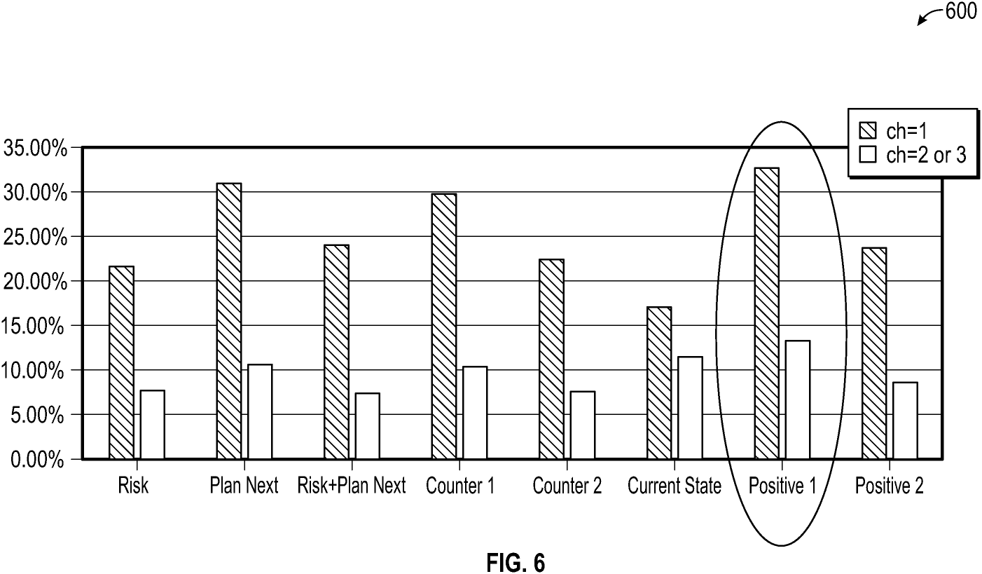

FIG. 6 shows a graph 600 illustrating the effects of presenting various explanations for the second implementation. The graph is made by measuring a change in the trust measures of the passenger. Table 5 shows a listing of trust measures and a representative statement indicating the trust measure.

TABLE 5

| Category | Representative statement for the category |
|---|---|
| 1 | “I definitely would have taken manual control.” |
| 2 | I probably would have taken manual control.” |
| 3 | I probably would have avoided taking manual control.” |
| 4 | “I definitely would have avoided taking manual control.” |

Graph 600 shows how the specified explanation affects the attitudes. The change between the trust categories of Table 5 is indicated by ch, where ch={1, 2, 3}. A ch =1 indicates that the effect of the explanation in changing the trust level of the test subject is weak. A change of ch=2 or ch= 3 indicates that effect of the explanation in changing the trust level of the test subject is strong. As seen from graph 600, the “Positive 1” explanation (“We managed to overtake the van without the need to stop and wait behind the van.”) is most effective in changing the trust level of the test subj ect.

In the third implementation, a mutual information model is used to select the best subset of explanations that can be presented to the passenger or human end user, rather than a single “best” explanation. The explanation set of the third implementation is the same as usedin the first and second implementation. In an illustrative example, the explanation set is W = {Risk, Plan-Next, Counterfactual 1, Counterfactual 2, Positive 1, Positive 2, Current State}. A subset B is a subset over the set W. Two examples are B₁ = {Risk, Counterfactual 1} and B₂ = {Positive 2, Current State}.

A mutual information measure is used to determine an amount of information that a selected subset (e.g., Bi or B₂) provides. For ajoint distribution over random variables X and Y, the mutual information measure (MI) is given by Eq, (3):

$$\begin{matrix}M I \left(X , Y\right) = {\sum }_{X , Y} P r \left(X = x , Y = y\right) log \left[P r \left(X = x , Y = y\right) /\right) \\ \left(\left(P r \left(X = x\right) P r \left(Y = y\right)\right)\right]\end{matrix}$$

For the present method, Y is a set of binary random variables (bᵢ) that correspond to the explanation ei. If bᵢ=1, the explanation eᵢ was presented to the test subject. If bᵢ=0, the explanation eᵢ was not presented to the test subject. Random variable X is the maxTrust, i.e., the maximum trust value received for a specific subset (Bi) of explanations.

The subset B1 is now considered for illustrative purposes. Theis subset can be rewritten as B1 = {b1, b2 } (where e1 = risk and e2 = counterfactual 1). If {b1 = 1, b2 = 1}, then the maxTrust is the maximum trust between the trust generated by the risk explanation and the trust generated the counterfactual1 explanation. If {b1 = 1, b2 = 0}, then the maxTrust is trust generated by the risk explanation. If {b1 = 0, b2 = 1}, then the maxTrust is the trust generated the counterfactual1 explanation. If {b1 = 0, b2 = 0}, then the maxTrust is the trust given by the test subject in the absence of any explanation.

It can be seen therefore that the mutual information measure MI is maximized when B is the set of all explanation (i.e., B = W). This maximization of MI when B=W is due to a chain rule for MI. In order to provide a balance between the number of explanations selected and the complexity of the explanation process, a cardinality constraint is introduced. The cardinality of a set B is a number of explanations in the set and is denoted by |B|.

In one embodiment, an optimization problem is solved to maximize the mutual information measure MI under a cardinality constraint β, as shown in Eq. (4):

$$M I \left(m a x T r u s t ; B \vert M\right) , s u c h t h a t \left|B\right| \leq β$$

In another embodiment, an optimization problem is solved to maximize Eq. (5):

$$M I \left(m a x T r u s t ; B \vert M\right) - α \left|B\right|$$

where α is an indicator of an amount of information for a set. Solving the optimization problem for Eq (5) balances a trade-off between cardinality and information.

An example of the third implementation is now discussed. Consider a scenario in which the assumed maneuver is LCOD and the assumed trust measure is “avoiding taking over”.

Table 6 shows the trust values for various subsets.

TABLE 6

| | |
|---|---|
| Explanation subset | Trust value |
| I(maxTrust; counter1, counter2, current state) | 0.007694689 nats |
| I(maxTrust; counter1, current state) | 0.003314 nats |
| I(maxTrust; counter1, counter2) | 0.002986 nats |
| I(maxTrust; counter2, current state) | 0.007477 nats |
| I(maxTrust; counter1) | 0.000111 nats |
| I(maxTrust; counter2) | 0.002842 nats |
| I(maxTrust; current state) | 0.003175 nats |

From Table 6, when alpha=0.004 in Eq. (5), it is determined that a best choice in a trade-off between explanation complexity (i.e., a size of a subset) and a mutual information, (i.e., its impact on the trust measure can be found by selecting I(maxTrust; counter2, current state). A similar choice can be reached using beta = 2 in Eq. (4).

The explanation can be presented to the driver or passenger using a variety of signal interfaces. In one option, the explanation can be presented as text on the HMI 60. In another option, the explanation can be presented an audible presented such as a voice reading the explanation. In yet another option, a combination of visual and audio presentation can be used.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a machine, comprising:
generating a set of explanations related to a machine behavior of the machine;
generating a model that relates an explanation for the machine behavior taken by the machine in response to a scenario to a trust level that a human has in the machine behavior when the explanation is presented to the human, the explanation being selected from the set of explanations;
performing the machine behavior in response to the scenario;
selecting, using the model, the explanation when the machine behavior is taken by the machine; and
presenting the explanation to the human.

2. The method of claim 1, wherein generating the model further comprises showing the scenario, the machine behavior and the explanation to a test subject and recording the trust level registered by the test subject for the machine behavior based on the explanation.

3. The method of claim 1, wherein the model is at least one of: (i) tailored to a demographic of the human; and (ii) tailored to the scenario.

4. The method of claim 1, wherein the machine is a vehicle, the scenario is a traffic scenario and the machine behavior is a maneuver of the vehicle for the traffic scenario.

5. The method of claim 1, wherein the model includes the trust level of a test subject and the explanation is selected that generates a maximum response from the test subject for the trust level.

6. The method of claim 1, wherein the model includes an effectiveness of the explanation in increasing the trust level that occurs between a first showing of the machine behavior to a test subject without the explanation and a second showing of the machine behavior to the test subject with the explanation.

7. The method of claim 1, further comprising selecting a subset of explanations to present to the human, wherein the subset is selected using at least one of: (i) optimizing a mutual information measure with respect to a constraint on a cardinality of the subset; and (ii) optimizing the mutual information measure that balances a trade-off between the cardinality and information.

8. A system, comprising:
a processor configured to:
generate a set of explanations related to a behavior of the system;
generate a model that relates an explanation for the behavior taken in response to a scenario to a trust level that a human has in the behavior when the explanation is presented to the human, the explanation being selected from the set of explanations;
perform the behavior in response to the scenario;
select, using the model, the explanation when the behavior is taken; and
present the explanation to the human.

9. The system of claim 8, wherein the processor is further configured to generate the model by showing the scenario, the behavior and the explanation to a test subject and recording the trust level registered by the test subject for the behavior based on the explanation.

10. The system of claim 8, wherein the processor is further configured to perform at least one of: (i) tailoring the model to a demographic of the human; and (ii) tailoring the model to the scenario.

11. The system of claim 8, wherein the model includes a record of the trust level of a test subject and the explanation is selected that generates a maximum response from the test subject for the trust level.

12. The system of claim 8, wherein the model includes a record of an effectiveness of the explanation in increasing the trust level that occurs between a first showing of the behavior to a test subject without the explanation and a second showing of the behavior to the test subject with the explanation.

13. The system of claim 8, wherein the processor is further configured to select a subset of explanations to present to the human by performing at least one of:
(i) optimizing a mutual information measure with respect to a constraint on a cardinality of the subset; and (ii) optimizing the mutual information measure that balances a trade-off between the cardinality and information.

14. An autonomous vehicle, comprising:
a processor configured to:
generate a set of explanations related to a behavior of the autonomous vehicle;
generate a model that relates an explanation for a maneuver taken by the autonomous vehicle in response to a traffic scenario to a trust level that a human has in the autonomous vehicle when the explanation is presented to the human, the explanation being selected from the set of explanations;
perform the maneuver at the autonomous vehicle in response to the traffic scenario;
select, using the model, the explanation for the maneuver when the autonomous vehicle performs the maneuver; and
present the explanation to the human.

15. The autonomous vehicle of claim 14, wherein the processor is further configured to generate the model by showing the traffic scenario, the maneuver and the explanation to a test subject and recording the trust level registered by the test subject for the maneuver based on the explanation.

16. The autonomous vehicle of claim 14, wherein the processor is further configured to perform at least one of: (i) tailoring the model to a demographic of the human and (ii) tailoring the model to the scenario.

17. The autonomous vehicle of claim 14, wherein the model includes a record of the trust level of a test subject and the explanation is selected that generates a maximum response from the test subject for the trust level.

18. The autonomous vehicle of claim 14, wherein the model includes a record of an effectiveness of the explanation in increasing the trust level that occurs between a first showing of the maneuver to a test subject without the explanation and a second showing of the maneuver to the test subject with the explanation.

19. The autonomous vehicle of claim 14, wherein the processor is further configured to select a subset of explanations to present to the human by performing at least one of: (i) optimizing a mutual information measure with respect to a constraint on a cardinality of the subset; and (ii) optimizing the mutual information measure that balances a trade-off between the cardinality and information.

20. The autonomous vehicle of claim 14, wherein the processor is configured to generate the model using a simulation of the traffic scenario in an offline mode and select the explanation in response to a real-time occurrence of the traffic scenario in an online mode.
